(19) United States
(12) Patent Application Publication
(10) Pub. No.: US 2004/0032623 A1
(43) Pub. Date: Feb. 19, 2004

(54) Method of recording communication process by email

(75) Inventor: Ko-Meng Chen, Hou Lung Jen (TW)

Correspondence Address: BROWDY AND NEIMARK, P.L.L.C., 624 NINTH STREET, NW, SUITE 300, WASHINGTON, DC, 20001-5303, US

(73) Assignee: Teco Image Systems Co., Ltd., Taipei (TW)

(21) Appl. No.: 10/217,124

(22) Filed: Aug. 13, 2002

(51) Int. Cl. B41F 1/00; G06F 15/00; H04N 1/00

(52) U.S. Cl. 358/402; 358/1.15

(57) ABSTRACT

A method of recording the communication processes for a facsimile machine during faxing out or receiving a document is provided. The communication processes are recorded in terms of a table or a list and then converted into an electronic document or image file before sent to a predetermined individuals for reference at a specific time or immediately by emails when a specific time comes.

### BACKGROUND OF THE INVENTION

1. Field of the Invention

The present invention relates to a method of recording the communication processes by email and, more particularly, to a method having steps of recording the communication processes during faxing out or receiving a document in terms of a table or a list, and sending this recorded table or list to predetermined individuals for reference if a predetermined time comes.

2. Description of the Prior Art

A widely used communication device like Internet-Faxes (I-Faxes) can transmit fax data by emails on the Internet, and can be operated under a multi-user mode for transmission of image data by emails too.

However, when in use, this kind of communication device neither records the communication processes such as a communication protocol of T.30 while data transmission or reception nor sends out these communication processes in terms of a table by emails at a specific time or immediately if the specific time comes, hence undermining its management efficiency.

### SUMMARY OF THE INVENTION

Accordingly, the primary objective of the present invention is to propose a method of recording the communication process during one facsimile machine receives and transmits data by emails so as to enhance its management efficiency.

To satisfy the above objective, in the present invention, a document to be transmitted is inputted into a facsimile machine. The communication processes while faxing this document out or receiving this document are then recorded in terms of a table or a list. Next, this recorded table or list is converted into an electronic document or an image file, which is finally sent to a predetermined individual or a group of people for reference by emails as a predetermined time comes.

The various objects and advantages of the present invention will be more readily understood from the following detailed description when read in conjunction with the appended drawing, in which:

### BRIEF DESCRIPTION OF THE DRAWINGS

FIG. 1 is a flowchart of the present invention.

### DETAILED DESCRIPTION OF THE PREFERRED EMBODIMENT

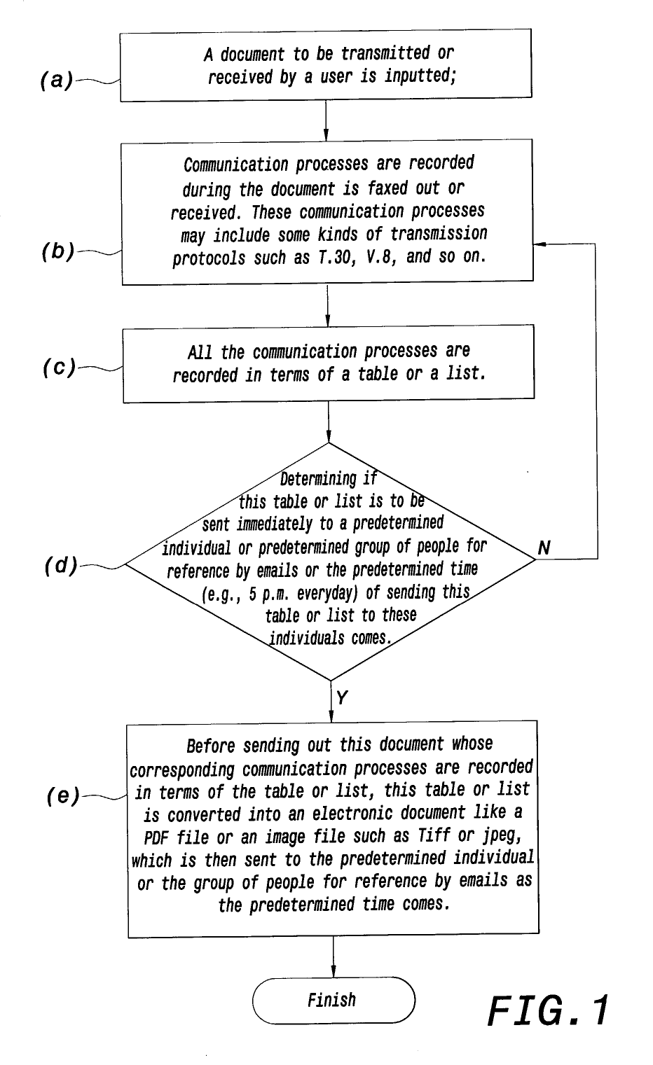

FIG. 1 shows a flowchart of the present invention. This invention is applicable to a facsimile machine having the I-Fax function. The method includes following steps of:

(a) A document to be transmitted or received by a user is inputted to the facsimile machine;

(b) Communication processes are recorded during the document is faxed out or received. These communication processes may include some kinds of transmission protocols such as T.30, V.8, and so on.

(c) All the communication processes are recorded in terms of a table or a list.

(d) Determining if this table or list is to be sent immediately to a predetermined individual or predetermined group of people for reference by emails or the predetermined time (e.g., 5 p.m. everyday) of sending this table or list to these individuals comes.

(e) Before sending out this document whose corresponding communication processes are recorded in terms of the table or list, this table or list is converted into an electronic document like a PDF file or an image file such as Tiff or jpeg, which is then sent to the predetermined individual or the group of people for reference by emails as the predetermined time comes.

Thereby, all the communication processes are recorded to enhance the management efficiency of the facsimile machine.

To sum up, the present invention is characterized in that all the communication processes are recorded in terms of a table or list during faxing out or receiving a document, and this table or list will be sent to some specific individuals for reference by emails at a specific time or immediately. Therefore, the management efficiency of the communication device can be greatly enhanced.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A method of recording communication processes during faxing out and receiving a document by a facsimile machine, said method comprising the steps of:
(a) recording the communication processes during faxing out and receiving the document in terms of a table or a list; and
(b) sending said recorded table or list to a predetermined individual or a predetermined group of people for reference by emails as a predetermined time comes.

2. The method as claimed in claim 1, further comprising a step of converting said table or list into an electronic document or an image file before sent out.

3. The method as claimed in claim 1, wherein said facsimile machine has a function of the Internet-Fax.
